(19) United States
(12) Patent Application Publication
(10) Pub. No.: US 2016/0101978 A1
(43) Pub. Date: Apr. 14, 2016

(54) ClO2 EMISSION APPARATUS AND ClO2 GENERATOR

(71) Applicant: PURGOFARM CO, LTD., Yongin (KR)

(72) Inventor: JongRak Kim, Yongin (KR)

(73) Assignee: PURGOFARM CO, LTD., Yongin (KR)

(21) Appl. No.: 14/797,382

(22) Filed: Jul. 13, 2015

(30) Foreign Application Priority Data
Oct. 13, 2014 (KR) 10-2014-0137451

(51) Int. Cl. C01B 11/02

(52) U.S. Cl. CPC C01B 11/024

(57) ABSTRACT

Provided is a chlorine dioxide emission apparatus. The apparatus includes: a body configured to provide a migration route of a chlorine dioxide; a chlorine dioxide generator that is disposed inside of the body, and has a first space and a second space that store respectively a first raw material and a second raw materials which are mixed with each other to generate the chlorine dioxide; and a carrier storage unit configured to store a carrier that is disposed in the migration route and is able to adsorb the chlorine dioxide.

### CROSS-REFERENCE TO RELATED APPLICATION

This application claims priority under 35 U.S.C. §119 from Korean Application No. 10-2014-0137451 filed on Oct. 13, 2014, the subject matter of which is incorporated herein by reference.

### BACKGROUND OF THE DISCLOSURE

1. Field of the Disclosure

The present invention relates to a chlorine dioxide emission apparatus and a chlorine dioxide generator.

2. Description of the Related Art

Due to an environmental degradation, a disease such as respiratory disease caused by virus or bacteria may have been increased.

In the case of Saudi Arabia, human bodies had been infected with MERS-CoV which is similar to SARS such that a large number of deaths had occurred and a damage caused by a flu virus had been widely spread.

To prevent a damage caused by such virus or bacteria, a mask may be worn to prevent the damage in advance. However, such a passive prophylactic measure may have a limitation on preventing the disease caused by virus or bacteria.

Accordingly, a study on a device to prevent virus or bacteria may have been progressed more aggressively.

### SUMMARY

The present invention may provide a chlorine dioxide emission apparatus and a chlorine dioxide generator that is able to control a point of time of use and to emit a chlorine dioxide consistently.

In accordance with an aspect of the present invention, a chlorine dioxide emission apparatus includes: a body configured to provide a migration route of a chlorine dioxide; a chlorine dioxide generator that is disposed inside of the body, and has a first space and a second space that store respectively a first raw material and a second raw materials which are mixed with each other to generate the chlorine dioxide; and a carrier storage unit configured to store a carrier that is disposed in the migration route and is able to adsorb the chlorine dioxide.

The carrier includes a silica gel.

At least a portion of the chlorine dioxide generator is formed of a material that prevents a leakage of the first raw material and the second raw material and through which the chlorine dioxide can pass.

The carrier storage unit has one side adjacent to the chlorine dioxide generator and the other side opposite to the one side, and the chlorine dioxide is emitted to an external of the body through an area of the body adjacent to the other side of the carrier storage unit.

The carrier storage unit has one side adjacent to the chlorine dioxide generator and the other side opposite to the one side, and a penetration hole, through which the chlorine dioxide can pass, is formed in the one side and the other side of the carrier storage unit, or the one side and the other side of the carrier storage unit are formed of a material that the chlorine dioxide can penetrate.

An area of the body opposite to an area between the chlorine dioxide generator and the carrier storage unit prevents the chlorine dioxide from being emitted to an external of the body.

At least one of the chlorine dioxide generator and the carrier storage unit is replaceable, and the body has an opening for a replacement of at least one of the chlorine dioxide generator and the carrier storage unit.

The body is formed of a flexible material, and is bent by an external force to connect the first space and the second space so that the first raw material and the second raw material are mixed.

The chlorine dioxide generator includes: a first material storage unit that forms the first space; a second material storage unit that is located inside of the first material storage unit and forms the second space; and a needle that is disposed inside of the first material storage unit and protruded toward one side of the second material storage unit, and the body comprises a pressing unit that transmits a force to move the needle to the second material storage unit according to user's operation, and the pressing unit penetrates a guide hole of the body and may move along a side of the guide hole.

A crease is formed in the first material storage unit.

The carrier storage unit has one side adjacent to the chlorine dioxide generator and the other side opposite to the one side and makes a discharge velocity of chlorine dioxide flowing out to the other side to be smaller than an inflow velocity of chlorine dioxide flowing into the one side.

The carrier storage unit gradually increases a chlorine dioxide emission amount during a first period, maintains the chlorine dioxide emission amount constantly during a second period after the first period, and gradually decreases the chlorine dioxide emission amount during a third period after the second period, and the second period is greater than the first period.

In accordance with another aspect of the present invention, a chlorine dioxide generator includes: a first material storage unit configured to store a first raw material; and a second material storage unit, which is disposed inside of the first material storage unit, configured to store a second raw material; wherein the first raw material and the second raw material are mixed to generate a chlorine dioxide when the second material storage unit is broken by an external force.

The second material storage unit is formed of a rigid material as compared with the first material storage unit.

One of the first raw material and the second raw material comprises a sodium chlorite, and the other of the first raw material and the second raw material comprises an acid group feed material.

The acid group feed material includes at least one of citric acid (C6H8O7), acetic acid (CH3COOH), and lactic acid (CH3CHOHCOOH).

At least a portion of the first material storage unit is formed of a low density polyethylene (LDPE) or a linear low density polyethylene (LLDPE).

The chlorine dioxide generator further includes: a carrier storage unit in which the first material storage unit is disposed; and a carrier, which is disposed between an inner surface of the carrier storage unit and the first material storage unit, configured to adsorb the chlorine dioxide.

A discharge velocity of chlorine dioxide of the carrier storage unit is smaller than a discharge velocity of chlorine dioxide of the first material storage unit, when the discharge velocity of chlorine dioxide that is emitted from the first material storage unit is increased.

A discharge velocity of chlorine dioxide of the carrier storage unit is larger than a discharge velocity of chlorine dioxide of the first material storage unit, when the discharge velocity of chlorine dioxide that is emitted from the first material storage unit is decreased. The chlorine dioxide generator further may comprise a carrier configured to adsorb the chlorine dioxide; and a carrier storage unit configured to store the carrier, wherein the carrier storage unit may be disposed in a space between the first material storage unit and the second material storage unit.

The carrier may absorb chlorine dioxide which passes through the carrier storage unit as the pressure of chlorine dioxide inside the carrier storage unit is increased.

The carrier may emit the absorbed chlorine dioxide which passes through the carrier storage unit as the pressure of chlorine dioxide inside the carrier storage unit is decreased.

The thickness of the carrier storage unit may be smaller than the thickness of the first material storage unit.

### BRIEF DESCRIPTION OF THE DRAWINGS

The objects, features and advantages of the present invention will be more apparent from the following detailed description in conjunction with the accompanying drawings, in which:

FIG. 1 and FIG. 4 are diagrams illustrating a chlorine dioxide emission apparatus according to a first embodiment of the present invention;

FIG. 2 is a graph illustrating a chlorine dioxide emission amount depending on a time in a chlorine dioxide generator;

FIG. 3 is a chlorine dioxide emission amount depending on a time in a chlorine dioxide generator and a carrier storage unit;

FIG. 5, FIG. 8, and FIG. 9 illustrate at least one of replaceable chlorine dioxide generator and carrier storage;

FIG. 6 and FIG. 7 illustrate a chlorine dioxide emission apparatus according to a second embodiment and a third of embodiment of the present invention; and

FIG. 10 to FIG. 12 illustrate a chlorine dioxide generator having various shapes.

### DETAILED DESCRIPTION OF EXEMPLARY EMBODIMENTS

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

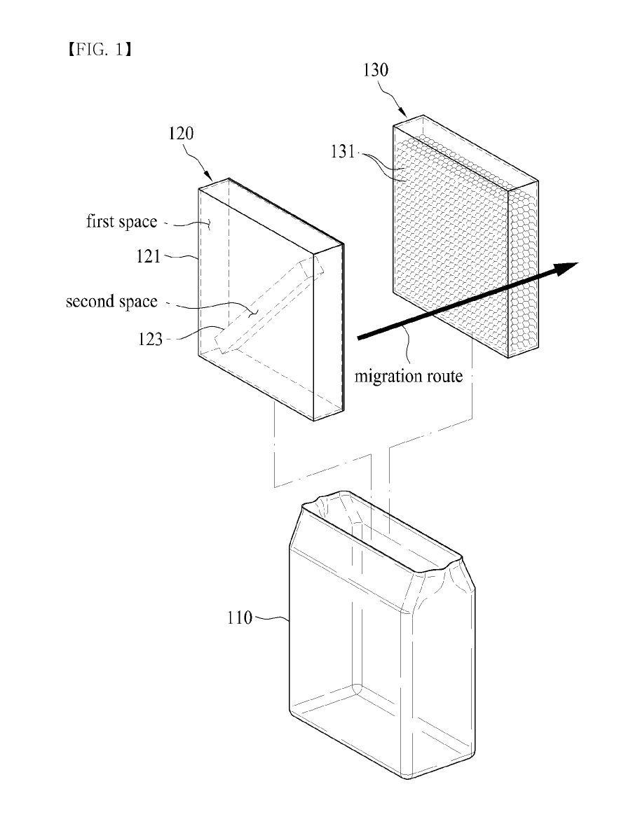

FIG. 1 is a diagram illustrating a chlorine dioxide emission apparatus according to a first embodiment of the present invention.

Referring to FIG. 1, the chlorine dioxide emission apparatus according to the first embodiment of the present invention may include a body 110, a chlorine dioxide generator 120, and a carrier storage unit 130.

The body 110 may provide a migration route of chlorine dioxide. The material of body 110 may be various, and thus the body 110 may be formed of a plurality of materials. The material of body 110 will be described later in detail.

The chlorine dioxide generator 120 may be disposed inside of body 110 and have a first space and a second space. The first space and the second space may store a first raw material and a second raw material respectively. In this place, the first raw material and the second raw material may be mixed to generate a chlorine dioxide.

One of the first raw material and the second raw material is sodium chlorite (NaClO₂), and the other may be an acidic group feed material. When sodium chlorite is decomposed into Na+ and ClO₂—, the acid group feed materials may form ClO₂ by losing the electron of ClO₂—.

In addition, the acidic group feed material may be a material obtained by mixing a solvent such as water with an acid group. When the acidic group feed material may include at least one of citric acid (C₆H₈O₇), acetic acid (CH₃COOH), and lactic acid (CH₃CHOHCOOH) so as to reduce the damage on human body, e.g., the damage by hydrochloric acid.

Since the acidic group feed material such as the citric acid, the acetic acid, and the lactic acid is a subacid material, it is not only harmless to the human body but also easy to handle and easy to be obtained.

As shown in FIG. 1, the chlorine dioxide generator 120 may include a first material storage unit 121 and a second material storage unit 123. The first material storage unit 121 and the second material storage unit 123 may form the first space and the second space respectively, and the second material storage unit 123 may be disposed inside of the first material storage unit 121.

At this time, the first material storage unit 121 may be formed of a material which can be folded or bent by user's operation, and the second material storage unit 123 may be formed of a rigid material such as glass.

When a user applies a force to the body 110, the first material storage unit 121 and the second material storage unit 123 may be connected while the second material storage unit 123 inside of the first material 121 is smashed or broken, and, accordingly, the first raw material and the second raw material may be mixed. Thus, a chlorine dioxide may be generated as the first raw material and the second raw material are mixed.

The body 110 may be formed of a flexible material in order that user applies a force to the body 110 to smash or break the second material storage unit 123. Thus, the first space and the second space may be connected as the body 110 is bent by an external force such that the first raw material and the second raw material may be mixed.

In this case, at least a portion of the first material storage unit 121 may be formed of a low density polyethylene (LDPE) or a linear low density polyethylene (LLDPE). The LDPE or the LLDPE may emit chlorine dioxide to the outside of the first material storage unit 121, but may prevent the first raw material from being leaked to the outside of the first material storage unit 121.

In the meantime, the carrier storage unit 130 of FIG. 1 may be disposed on the migration route and store a carrier 131 which is able to adsorb the chlorine dioxide. The carrier 131 may include a silica gel, but is not limited thereto.

The carrier 131 may adsorb the chlorine dioxide, and the discharge velocity of chlorine dioxide flowing out from the carrier storage unit 130 may be smaller than the inflow velocity of chlorine dioxide flowing into the carrier storage unit 130.

That is, when the carrier storage unit 130 may have one side adjacent to the chlorine dioxide generator 120 and the other side of the carrier storage unit 130 opposite to the one side, the carrier storage unit 130 may make the discharge velocity of chlorine dioxide flowing out to the other side to be smaller than the inflow velocity of chlorine dioxide flowing into the one side.

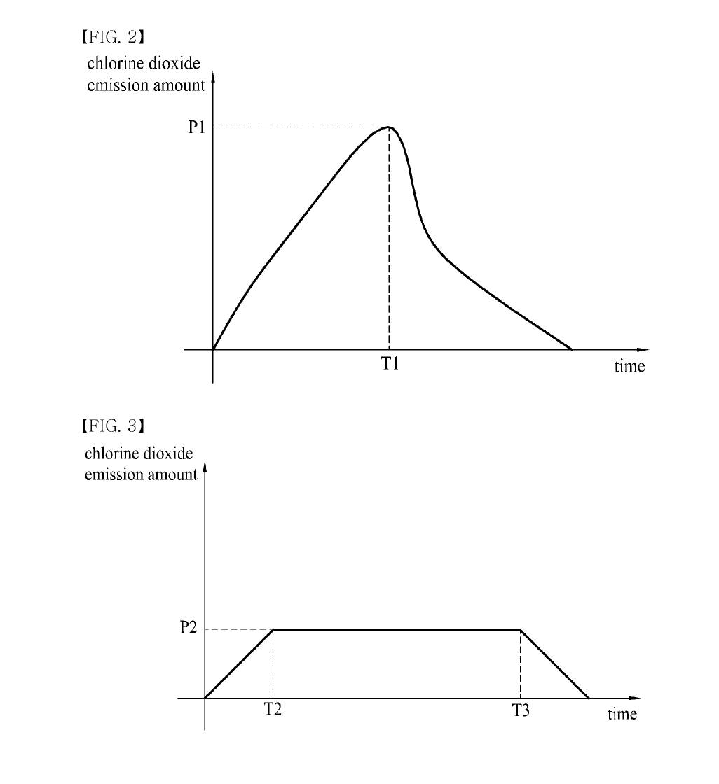

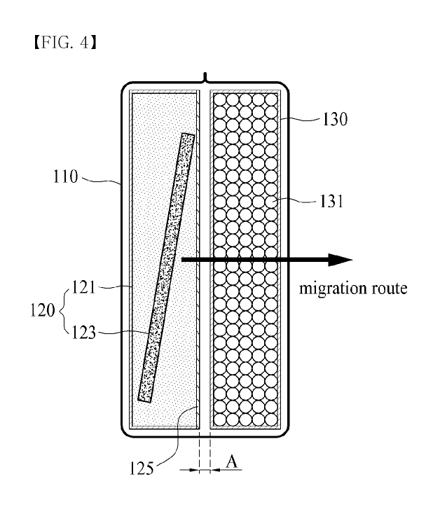

FIG. 2 is a graph illustrating a chlorine dioxide emission amount depending on a time in a chlorine dioxide generator 120, and FIG. 3 is a chlorine dioxide emission amount depending on a time in a chlorine dioxide generator 120 and a carrier storage unit 130

As shown in FIG. 2, when the first raw material and the second raw material are mixed, the internal pressure of the chlorine dioxide generator 120 may be increased as the chlorine dioxide is generated, such that the discharge velocity of chlorine dioxide may be increased.

Thus, as the discharge velocity of chlorine dioxide is increased, the chlorine dioxide emission amount may be rapidly reduced after the chlorine dioxide emission amount reaches a maximum P1.

Meanwhile, as shown in FIG. 3, even if the chlorine dioxide generator 120 emits a large amount of chlorine dioxide in a short time, the carrier 131 of the storage unit 130 may adsorb the chlorine dioxide, so that the chlorine dioxide emission amount per unit time of storage unit 130 may be reduced.

In addition, after the adsorption of the carrier 131 is saturated, the carrier 131 may adsorb the chlorine dioxide supplied from the chlorine dioxide generator 120 up to the emitted amount, such that the carrier storage unit 130 may maintain the chlorine dioxide emission amount per unit time at a certain level.

Accordingly, as shown in FIG. 3, the carrier storage unit 130 may gradually increase the chlorine dioxide emission amount during a first period (0-T2). The carrier storage unit 130 may maintain the chlorine dioxide emission amount constantly during a second period (T2-T3) after the first period (0-T2).

In addition, the carrier storage unit 130 may gradually decrease the chlorine dioxide emission amount during a third period (T3-) after the second period (T2-T3). At this time, the second period (T2-T3) may be greater than the first period (0-T2).

In case of the chlorine dioxide emission apparatus according to an embodiment of the present invention, a user may select the use time of the chlorine dioxide emission apparatus. That is, the user may apply an external force to the chlorine dioxide generator 120 so that the first raw material and the second raw material may be mixed and a chlorine dioxide may be generated. Accordingly, the user may select the generation time of chlorine dioxide.

In addition, even if the chlorine dioxide generator 120 emits a large amount of chlorine dioxide rapidly, the discharge velocity of chlorine dioxide may be adjusted by the carrier storage unit 130 and the chlorine dioxide may be emitted for a long time at a constant speed, such that user may be able to use the chlorine dioxide emission apparatus for a long time.

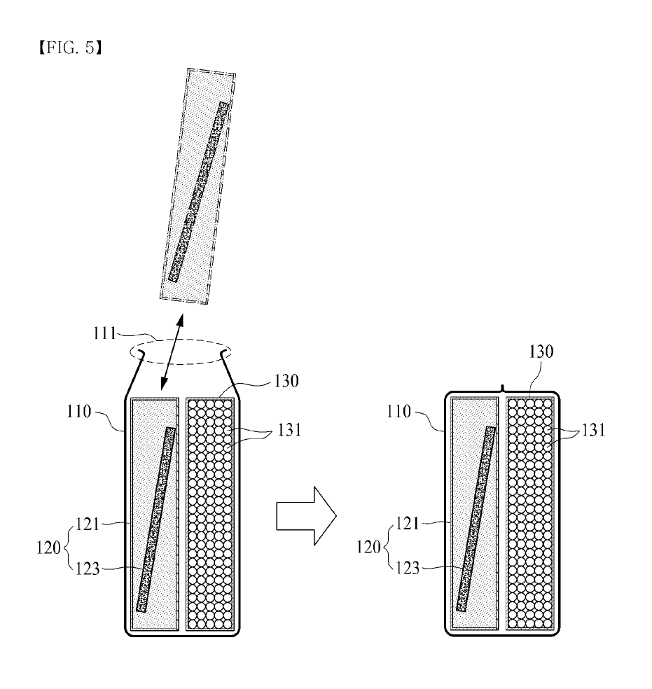

In the meantime, FIG. 4 illustrates a side cross-sectional view of the chlorine dioxide emission apparatus according to an embodiment of the present invention. As described above, because the chlorine dioxide generated by the chlorine dioxide generator 120 should pass through the carrier storage unit 130, at least a part of the chlorine dioxide generator 120 may be formed of a material that can prevent a leakage of the first raw material and the second raw material and through which the chlorine dioxide can pass.

For example, one side 125 of the chlorine dioxide generator 120 adjacent to the carrier storage unit 130 may be formed of a material capable of transmitting the chlorine dioxide, but the area other than the one side 125 may be formed of a material that can prevent the transmission of the chlorine dioxide.

At this time, one side of the chlorine dioxide generator 120 may be formed of a material that can prevent the leakage of the first raw material and the second raw material like the low density polyethylene (LDPE) or the linear low density polyethylene (LLDPE).

In addition, the chlorine dioxide generator 120 other than the one side may be formed of a material that can prevent the leakage of the chlorine dioxide, the first raw material, and the second raw material.

At this time, the carrier storage unit 130 may have one side adjacent to the chlorine dioxide generator 120 and the other side opposite to the one side, and the chlorine dioxide may be emitted to the outside of body 110 through the body 110 area adjacent to the other side of the carrier storage unit 130.

That is, since the chlorine dioxide generator 120 and the carrier storage unit 130 are disposed in the inside of body 110 along the migration route of the chlorine dioxide and the chlorine dioxide should pass through the carrier storage unit 130, the chlorine dioxide may be introduced through one side of the carrier storage unit 130 and the chlorine dioxide may be leaked through the other side of the carrier storage unit 130. Accordingly, the chlorine dioxide may be emitted to the outside of body 110 through the body 110 area adjacent to the other side of the carrier storage unit 130.

At this time, the carrier storage unit 130 may be formed of a material through which the chlorine dioxide can pass like the LDPE or the LLDPE, or a penetration hole may be formed on a surface of the carrier storage unit 130.

That is, the carrier storage unit 130 may have one side adjacent to the chlorine dioxide generator 120 and the other side opposite to the one side, and a penetration hole through which the chlorine dioxide can pass may be formed in the one side and the other side of the carrier storage unit 130, or the one side and the other side of the carrier storage unit 130 may be formed of a material through which the chlorine dioxide can pass. In this case, the diameter of the penetration hole may be smaller than the diameter of the carrier 131.

In addition, the body 110 may be also formed of a material through which the chlorine dioxide can pass like the LDPE or the LLDPE or a penetration hole may be formed on the surface of body 110.

Although the chlorine dioxide generator 120 and the carrier storage unit 130 are separated in FIG. 4, unlike this, the chlorine dioxide generator 120 and the carrier storage unit 130 may be connected.

In the meantime, as described above, the chlorine dioxide may be discharged to the outside of body 110 after moving from the chlorine dioxide generator 120 to the carrier storage unit 130. If the chlorine dioxide is leaked through the body 110 area (A) between the chlorine dioxide generator 120 and the carrier storage unit 130 unlike the embodiment of the present invention, the emission time of the chlorine dioxide passing through the body 110 may be reduced.

Thus, in the case of the chlorine dioxide emission apparatus according to an embodiment of the present invention, the area A of body 110 opposite to the area between the chlorine dioxide generator 120 and the carrier storage unit 130 may prevent the chlorine dioxide from being emitted to the outside of the body 110.

As shown in FIG. 5, at least one of the chlorine dioxide generator 120 and the carrier storage unit 130 may be replaceable. At this time, the body 110 may have an opening 111 for the replacement of at least one of the chlorine dioxide generator 120 and the carrier storage unit 130.

For example, if the chlorine dioxide generator 120 is not able to generate the chlorine dioxide any more, user may operate the body 110 of zipper bag style to form the opening 111 of body 110.

Thereafter, the user may take out the chlorine dioxide generator 120 inside of body 110 to the outside of body 110 through the opening 111 and insert a new chlorine dioxide generator 120 into the inside of body 110 and close the opening 111.

FIG. 5 illustrates the replacement of the chlorine dioxide generator 120, but is not limited thereto and it is possible to replace the carrier storage unit 130 through the opening 111 of body 110.

Next, the chlorine dioxide emission apparatus according to a second embodiment and a third embodiment of the present invention is described with reference to drawings.

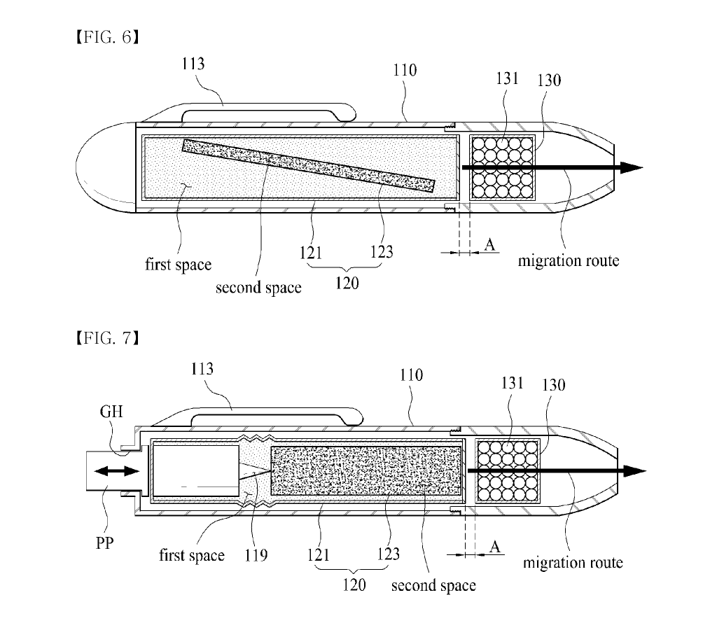

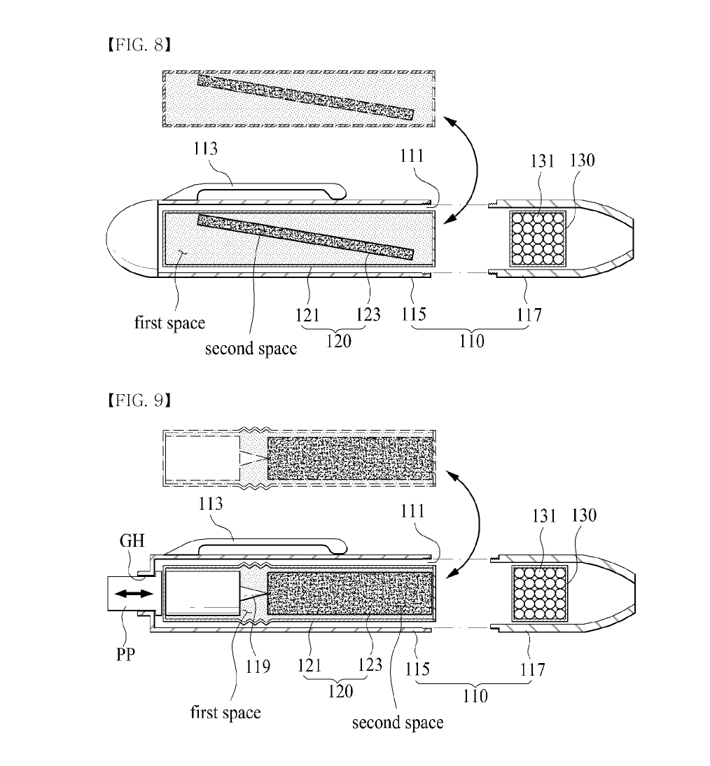

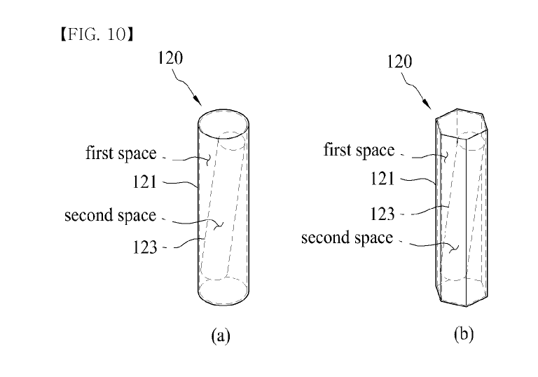

FIG. 6 and FIG. 7 illustrate a chlorine dioxide emission apparatus according to a second embodiment and a third of embodiment of the present invention. The chlorine dioxide emission apparatus according to the second embodiment and the third embodiment of the present invention may have a writing instrument shape equipped with a clip 113 that can be fixed to user's clothes or the like, but is not limited thereto.

As shown in FIG. 6, the chlorine dioxide emission apparatus according to the second embodiment of the present invention may include the body 110, the chlorine dioxide generator 120, and the carrier storage unit 130.

The body 110 may provide a migration route of chlorine dioxide, and may be formed of a plastic material that can be bent, but is not limited thereto.

Since the chlorine dioxide generator 120, the first raw material, the second raw material, the first material storage unit 121, and the second material storage unit 123 were described through the first embodiment, the explanation thereof will be omitted.

When user applies force to the body 110, the second material storage unit 123 may be smashed or broken while the body 110 is bent, and, therefore, the first raw material and the second raw material may be mixed. Thus, a chlorine dioxide may be generated as the first raw material and the second raw material are mixed.

Since the carrier storage unit 130 of FIG. 6 was described above through the first embodiment of the present invention, a detailed description thereof is omitted.

Meanwhile, as described above, since the chlorine dioxide generated by the chlorine dioxide generator 120 should pass through the carrier storage unit 130, at least a part of the chlorine dioxide generator 120 may be formed of a material that can prevent the leakage of the first raw material and the second raw material, and through which the chlorine dioxide generator 120 can pass.

For example, one side of the chlorine dioxide generator 120 adjacent to the carrier storage unit 130 may be formed of a material capable of transmitting the chlorine dioxide, but the area other than the one side may be formed of a material that can prevent the transmission of chlorine dioxide.

In addition, the other chlorine dioxide generator 120 except for the one side may be formed of a material that can prevent the leakage of the chlorine dioxide, the first raw material, and the second raw material.

At this time, the carrier storage unit 130 may have one side adjacent to the chlorine dioxide generator 120 and the other side opposite to the one side, and the chlorine dioxide may be emitted to the outside of the body 110 through body 110 area adjacent to the other side of the carrier storage unit 130.

The carrier storage unit 130 may be formed of a material through which the chlorine dioxide can pass like the LDPE or the LLDPE or a penetration hole may be formed on the surface of the carrier storage unit 130.

Although the chlorine dioxide generator 120 and the carrier storage unit 130 are separated in FIG. 6, unlike this, the chlorine dioxide generator 120 and the carrier storage unit 130 may be connected.

Similarly to the first embodiment of the first invention, the body 110 of the chlorine dioxide emission apparatus according to a second embodiment of the present invention may also prevent the chlorine dioxide between the chlorine dioxide generator 120 and the carrier storage unit 130 from being emitted to the outside of the body 110.

As shown in FIG. 8, at least one of the chlorine dioxide generator 120 and the carrier storage unit 130 may be replaceable. At this time, the body 110 may have an opening 111 for the replacement of at least one of the chlorine dioxide generator 120 and the carrier storage unit 130.

For example, the body 110 may include a first portion body 115 and a second portion body 117, and the first portion body 115 and the second portion body 117 may be fastened to each other. At this time, the opening 111 may be formed in the end of the first portion body 115 and the second portion body 117.

User may take out the chlorine dioxide generator 120 and the carrier storage unit 130 to the outside of body 110 through the opening 111 after disassembling the body 110 into the first portion body 115 and the second portion body 117, and combine the first portion body 115 and the second portion body 117 after inserting new chlorine dioxide generator 120 and carrier storage unit 130 into the inside of the first portion body 115 and the second portion body 117.

Next, a chlorine dioxide emission apparatus according to a third of embodiment of the present invention is described with reference to FIG. 7.

As shown in FIG. 7, the chlorine dioxide emission apparatus according to a third embodiment of the present invention may include the body 110, the chlorine dioxide generator 120, and the carrier storage unit 130.

The body 110 may provide a migration route of chlorine dioxide, and may be formed of a plastic material that can be bent, but is not limited thereto.

Since the chlorine dioxide generator 120, the first raw material, and the second raw material were described above through the first embodiment of the present invention, an explanation thereof is omitted.

The chlorine dioxide generator 120 may include a first material storage unit 121 that forms a first space, a second material storage unit 123 that is located inside of the first material storage unit 121 and forms a second space, and a needle 119 that is disposed inside of the first material storage unit 121 and protruded toward one side of the second material storage unit 123.

At this time, the body 110 may include a pressing unit PP that transmits a force to move the needle 119 to the second material storage unit 123 according to user's operation, the pressing unit PP may penetrate a guide hole GH of the body 110 and may move along the side of the guide hole GH.

That is, when user presses the pressing unit PP, the needle 119 may penetrate the second material storage unit 123, and, therefore, the first raw material and the second raw material may be mixed to generate a chlorine dioxide.

If the user presses the pressing unit PP, a crease may be formed in the first material storage unit 121 to facilitate the movement of the needle 119.

Since the carrier storage unit 130 of FIG. 7 was described above in detail through the first embodiment, a description thereof is omitted.

Meanwhile, as described above, because the chlorine dioxide generated by the chlorine dioxide generator 120 should pass through the carrier storage unit 130, at least a part of the chlorine dioxide generator 120 may be formed of a material that can prevent a leakage of the first raw material and the second raw material and through which the chlorine dioxide can pass.

For example, one side of the chlorine dioxide generator 120 adjacent to the carrier storage unit 130 may be formed of a material capable of transmitting the chlorine dioxide, but the area other than the one side may be formed of a material that can prevent the transmission of the chlorine dioxide.

In addition, the chlorine dioxide generator 120 other than the one side may be formed of a material that can prevent the leakage of the chlorine dioxide, the first raw material, and the second raw material.

At this time, the carrier storage unit 130 may have one side adjacent to the chlorine dioxide generator 120 and the other side opposite to the one side, and the chlorine dioxide may be emitted to the outside of body 110 through the body 110 area adjacent to the other side of the carrier storage unit 130.

The carrier storage unit 130 may be formed of a material through which the chlorine dioxide can pass like the LDPE or the LLDPE, or a penetration hole may be formed on a surface of the carrier storage unit 130.

Similarly to the first embodiment of the first invention, the body 110 of the chlorine dioxide emission apparatus according to a third embodiment of the present invention may also prevent the chlorine dioxide between the chlorine dioxide generator 120 and the carrier storage unit 130 from being emitted to the outside of the body 110.

As shown in FIG. 9, at least one of the chlorine dioxide generator 120 and the carrier storage unit 130 may be replaceable. At this time, the body 110 may have an opening 111 for the replacement of at least one of the chlorine dioxide generator 120 and the carrier storage unit 130.

For example, the body 110 may include the first portion body 115 and the second portion body 117, and the first portion body 115 and the second portion body 117 may be fastened to each other. At this time, the opening 111 may be formed in the end of the first portion body 115 and the second portion body 117.

User may take out the chlorine dioxide generator 120 and the carrier storage unit 130 to the outside of body 110 through the opening 111 after disassembling the body 110 into the first portion body 115 and the second portion body 117, and combine the first portion body 115 and the second portion body 117 after inserting new chlorine dioxide generator 120 and carrier storage unit 130 into the inside of the first portion body 115 and the second portion body 117.

The above described chlorine dioxide emission apparatus according to a first embodiment to a third embodiment of the present invention may be worn on the user's body to remove a virus or a bacteria before the virus or the bacteria permeates the user's body.

For example, if the chlorine dioxide emission apparatus according to a first embodiment of the present invention is provided with a strap or a necklace (not shown) so that user may hang the chlorine dioxide emission apparatus around the neck, a chlorine dioxide may be emitted around the user such that the bacteria or the virus may be removed.

In addition, since the chlorine dioxide emission apparatus according to a second embodiment and a third embodiment of the present invention includes the clip 113 provided in the pen-shaped body 110, when user attaches the chlorine dioxide emission apparatus according to a second embodiment and a third embodiment of the present invention to a clothes or the like, a chlorine dioxide may be emitted such that the bacteria or the virus around the user may be removed.

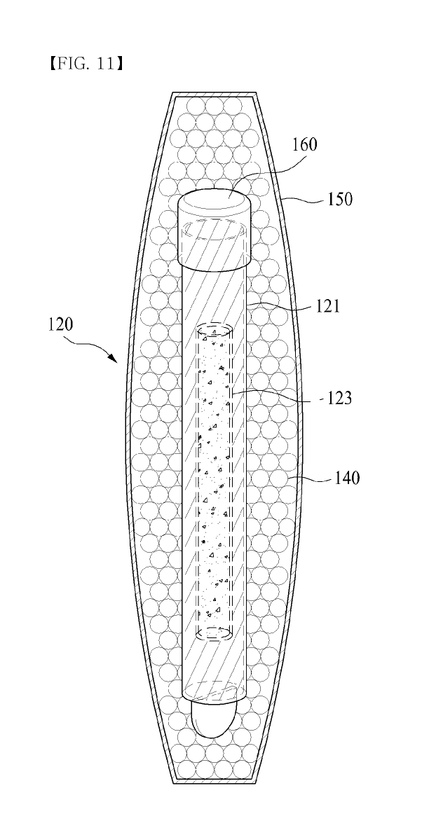

In the above description, the shape of the first material storage unit 121 and the second material storage unit 123 may be a hexahedron, but is not limited thereto, and may be implemented with various shapes such as a cylindrical shape or a hexagonal shape as shown in FIG. 10.

In addition, the first material storage unit 121 may be worn on the user's body independently to remove a virus or a bacteria before the virus or the bacteria permeates the user's body.

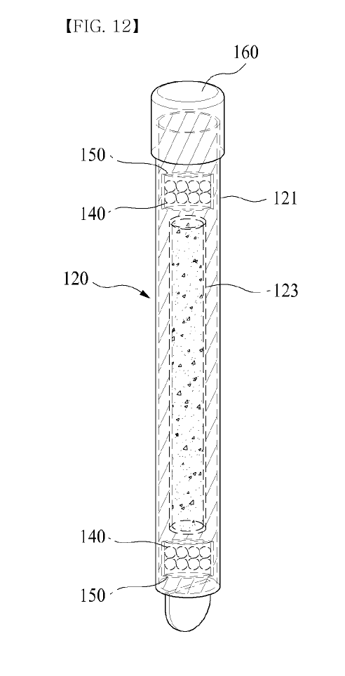

Meanwhile, as shown in FIG. 11, the chlorine dioxide generator 120 may further include a carrier storage unit 150 and a carrier 140. Since the first material storage unit 121 and the second material storage unit 123 of FIG. 11 were described in the above in detail, a description thereof is omitted.

The first material storage unit 121 may be disposed in an interior of the carrier storage unit 150, and the carrier 140 may be disposed in a space between an inner surface of the carrier storage unit 150 and the first material storage unit 121.

Accordingly, the carrier 140 may surround at least portion of an outer surface of the first material storage unit 121. In addition, the carrier storage unit 150 may be formed of LDPE or LLDPE to emit gaseous chlorine dioxide to the outside.

In this case, the carrier 140 may adsorb chlorine dioxide. For example, the carrier 140 may include a silica gel, and the silica gel may adsorb chlorine dioxide as the silica gel is a porous material. The component of the carrier 140 is not limited to the silica gel, but may include various materials that can adsorb chlorine dioxide.

The carrier 140 may emit the absorbed chlorine dioxide when the concentration of chlorine dioxide around the carrier 140 is low. In addition, when the concentration of chlorine dioxide around the carrier 140 is high, the carrier 140 may absorb chlorine dioxide and may be saturated.

Accordingly, the carrier 140 may extend a length of time during which chlorine dioxide is emitted from the carrier storage unit 150. That is, when the first raw material and the second raw material are mixed, the amount of generation of chlorine dioxide may be increased rapidly. Accordingly, the amount of chlorine dioxide emitted from the first material storage unit 121 may also be increased rapidly.

Since the carrier 140 can absorb chlorine dioxide as the concentration of chlorine dioxide inside the carrier storage unit 150 is increased, the amount of chlorine dioxide that is emitted from the carrier storage unit 150 may be smaller than the amount of chlorine dioxide that is emitted from the first material storage unit 121 during a first period.

That is, when the first material storage unit 121 emits chlorine dioxide, there may be a time period during which the discharge velocity of chlorine dioxide that is emitted from the first material storage unit 121 may be larger than the discharge velocity of chlorine dioxide that is emitted from the carrier storage unit 150.

Meanwhile, when the amount of chlorine dioxide that is emitted from the first material storage unit 121 is reduced, the concentration of chlorine dioxide inside the carrier storage unit 150 is reduced during a second period after the first period, such that the carrier 140 may emit the adsorbed chlorine dioxide.

Therefore, the amount of chlorine dioxide that is emitted from the carrier storage unit 150 may be greater than the amount of chlorine dioxide emitted from the first material storage unit 121.

Thus, the carrier storage unit 150 and the carrier 140 may serve to reduce a change of the amount of chlorine dioxide emitted from the first material storage unit 121.

That is, when the discharge velocity of chlorine dioxide that is emitted from the first material storage unit 121 is increased, the discharge velocity of chlorine dioxide of the carrier storage unit 150 may be smaller than the discharge velocity of chlorine dioxide of the first material storage unit 121.

In contrast, when the discharge velocity of chlorine dioxide that is emitted from the first material storage unit 121 is decreased, the discharge velocity of chlorine dioxide of the carrier storage unit 150 may be larger than the discharge velocity of chlorine dioxide of the first material storage unit 121.

The reference numeral 160 of FIG. 11 may be a cap which prevents the opening of the first material storage unit 121. The carrier storage unit 150 may be worn on the user's body independently to remove a virus or a bacteria before the virus or the bacteria permeates the user's body. Meanwhile, as shown in FIG. 12, the carrier storage unit 150 may be disposed in a space between the first material storage unit 121 and the second material storage unit 123, and may store the carrier 140.

The carrier storage unit 150 may be formed of LDPE or LLDPE such that gaseous chlorine dioxide passes through the carrier storage unit 150.

The carrier 140 of FIG. 12 may extend a length of time during which chlorine dioxide is emitted from the first material storage unit 121.

That is, when the first raw material and the second raw material are mixed, the amount of generation of chlorine dioxide may be increased rapidly during a first period.

The carrier 140 can absorb chlorine dioxide which passes through the carrier storage unit 150 as the pressure of chlorine dioxide inside the carrier storage unit 150 is increased.

In addition, as the amount of generation of chlorine dioxide may be decreased during a second period after the first period, the carrier 140 emits the absorbed chlorine dioxide. Accordingly, the carrier storage unit 150 also emits chlorine dioxide.

At this time, the thickness of the carrier storage unit 150 may be smaller than the thickness of the first material storage unit 121. Thus, it may be easy that the chlorine dioxide passes through the carrier storage unit 150 according to the pressure of the chlorine dioxide.

The carrier storage unit 150 and the carrier 140 may serve to reduce a change of the amount of chlorine dioxide emitted from the first material storage unit 121, and may extend a length of time during which chlorine dioxide is emitted from the first material storage unit 121.

The reference numeral 160 of FIG. 12 may be a cap which prevents the opening of the first material storage unit 121.

The first material storage unit 121 of FIG. 12 may be worn on the user's body independently to remove a virus or a bacteria before the virus or the bacteria permeates the user's body.

The chlorine dioxide emission apparatus and the ClO₂ generator according to an embodiment of the present invention may apply a force to the body to mix the first raw material and the second raw material so that a point of time of use may be selected.

The chlorine dioxide emission apparatus and the ClO₂ generator according to an embodiment of the present invention may emit a chlorine dioxide consistently by making the chlorine dioxide to pass through the carrier.

Although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A chlorine dioxide emission apparatus comprising:
a body configured to provide a migration route of a chlorine dioxide;
a chlorine dioxide generator that is disposed inside of the body, and has a first space and a second space that store respectively a first raw material and a second raw materials which are mixed with each other to generate the chlorine dioxide; and
a carrier storage unit configured to store a carrier that is disposed in the migration route and is able to adsorb the chlorine dioxide.

2. The chlorine dioxide emission apparatus of claim 1, wherein the carrier comprises a silica gel.

3. The chlorine dioxide emission apparatus of claim 1, wherein at least a portion of the chlorine dioxide generator is formed of a material that prevents a leakage of the first raw material and the second raw material and through which the chlorine dioxide can pass.

4. The chlorine dioxide emission apparatus of claim 3, wherein the carrier storage unit has one side adjacent to the chlorine dioxide generator and the other side opposite to the one side, and the chlorine dioxide is emitted to an external of the body through an area of the body adjacent to the other side of the carrier storage unit.

5. The chlorine dioxide emission apparatus of claim 3, wherein the carrier storage unit has one side adjacent to the chlorine dioxide generator and the other side opposite to the one side, and
a penetration hole, through which the chlorine dioxide can pass, is formed in the one side and the other side of the carrier storage unit, or
the one side and the other side of the carrier storage unit are formed of a material through which the chlorine dioxide can pass.

6. The chlorine dioxide emission apparatus of claim 1, wherein an area of the body opposite to an area between the chlorine dioxide generator and the carrier storage unit prevents the chlorine dioxide from being emitted to an outside of the body.

7. The chlorine dioxide emission apparatus of claim 1, wherein at least one of the chlorine dioxide generator and the carrier storage unit is replaceable, and the body has an opening for a replacement of at least one of the chlorine dioxide generator and the carrier storage unit.

8. The chlorine dioxide emission apparatus of claim 1, wherein the body is formed of a flexible material, and is bent by an external force to connect the first space and the second space so that the first raw material and the second raw material are mixed.

9. The chlorine dioxide emission apparatus of claim 1, wherein the chlorine dioxide generator comprises:
a first material storage unit that forms the first space;
a second material storage unit that is located inside of the first material storage unit and forms the second space; and
a needle that is disposed inside of the first material storage unit and protruded toward one side of the second material storage unit,
and the body comprises a pressing unit that transmits a force to move the needle to the second material storage unit according to user's operation, and
the pressing unit penetrates a guide hole of the body and may move along a side of the guide hole.

10. The chlorine dioxide emission apparatus of claim 9, wherein a crease is formed in the first material storage unit.

11. The chlorine dioxide emission apparatus of claim 1, wherein the carrier storage unit has one side adjacent to the chlorine dioxide generator and the other side opposite to the one side, and makes a discharge velocity of chlorine dioxide flowing out to the other side to be smaller than an inflow velocity of chlorine dioxide flowing into the one side.

12. The chlorine dioxide emission apparatus of claim 1, wherein the carrier storage unit gradually increases a chlorine dioxide emission amount during a first period, maintains the chlorine dioxide emission amount constantly during a second period after the first period, and gradually decreases the chlorine dioxide emission amount during a third period after the second period, and the second period is greater than the first period.

13. A chlorine dioxide generator comprising:
a first material storage unit configured to store a first raw material; and
a second material storage unit, which is disposed inside of the first material storage unit, configured to store a second raw material;
wherein the first raw material and the second raw material are mixed to generate a chlorine dioxide when the second material storage unit is broken by an external force.

14. The chlorine dioxide generator of claim 13, wherein the second material storage unit is formed of a rigid material as compared with the first material storage unit.

15. The chlorine dioxide generator of claim 13, wherein one of the first raw material and the second raw material comprises a sodium chlorite, and the other of the first raw material and the second raw material comprises an acid group feed material.

16. The chlorine dioxide generator of claim 15, wherein the acid group feed material comprises at least one of citric acid (C₆H₈O₇), acetic acid (CH₃COOH), and lactic acid (CH₃CHOHCOOH).

17. The chlorine dioxide generator of claim 13, wherein at least a portion of the first material storage unit is formed of a low density polyethylene (LDPE) or a linear low density polyethylene (LLDPE).

18. The chlorine dioxide generator of claim 13, further comprising:
a carrier storage unit in which the first material storage unit is disposed; and
a carrier, which is disposed between an inner surface of the carrier storage unit and the first material storage unit, configured to adsorb the chlorine dioxide.

19. The chlorine dioxide generator of claim 18, wherein a discharge velocity of chlorine dioxide of the carrier storage unit is smaller than a discharge velocity of chlorine dioxide of the first material storage unit, when the discharge velocity of chlorine dioxide that is emitted from the first material storage unit is increased.

20. The chlorine dioxide generator of claim 18, wherein a discharge velocity of chlorine dioxide of the carrier storage unit is larger than a discharge velocity of chlorine dioxide of the first material storage unit, when the discharge velocity of chlorine dioxide that is emitted from the first material storage unit is decreased.

21. The chlorine dioxide generator of claim 13, further comprising: a carrier configured to adsorb the chlorine dioxide; and
a carrier storage unit configured to store the carrier,
wherein the carrier storage unit is disposed in a space between the first material storage unit and the second material storage unit.

22. The chlorine dioxide generator of claim 21, wherein the carrier absorbs chlorine dioxide which passes through the carrier storage unit as the pressure of chlorine dioxide inside the carrier storage unit is increased.

23. The chlorine dioxide generator of claim 22, wherein the carrier emits the absorbed chlorine dioxide which passes through the carrier storage unit as the pressure of chlorine dioxide inside the carrier storage unit is decreased.

24. The chlorine dioxide generator of claim 23, wherein the thickness of the carrier storage unit is smaller than the thickness of the first material storage unit.
